(19) United States
(12) Patent Application Publication
(10) Pub. No.: US 2003/0198233 A1
(43) Pub. Date: Oct. 23, 2003

(54) Cross-connect switch and route monitoring assist apparatus

(76) Inventors: Yukio Suda, Yokohama (JP); Akio Yokotsuka, Yokohama (JP); Masayuki Tanaka, Yokohama (JP); Satoshi Nemoto, Yokohama (JP); Hidenori Sugai, Yokohama (JP); Atsushi Kawasaki, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/279,357

(22) Filed: Oct. 24, 2002

(30) Foreign Application Priority Data
Apr. 17, 2002 (JP) 2002-115334

(51) Int. Cl. H04L 12/28; H04Q 7/00

(52) U.S. Cl. 370/395.71; 370/314

(57) ABSTRACT

The invention relates to provide a cross-connect switch and a route monitoring assist apparatus both suitable for a synchronous transfer mode. An object of the invention is to attain cross-connect at a low cost with reliability in a much higher rate group than in the conventional example. To this end, the invention provides a cross-connect switch comprising a multiport storage section having a plurality of read ports randomly accessible and a plurality of write ports to which data of a plurality of channels that are time-division-multiplexed are input individually in parallel; an address storage section for storing addresses to be supplied to the respective read ports; and a controlling section for writing data in units of a plurality of channels by supplying write addresses sequentially to each of the write ports, and for supplying addresses stored in the address storage section to the respective read ports.

### BACKGROUND OF THE INVENTION

1. Field of the Invention

The present invention relates to a cross-connect switch and a route monitoring assist apparatus in a node of a transmission system to which a synchronous transfer mode is applied. The cross-connect switch serves to assign high-speed-interface signals that are supplied from incoming lines to desired outgoing lines that lead to desired destinations, and the route monitoring assist apparatus serves to extract and communicate to an outside system pieces of desired information that are multiplexed in such a signal and should be monitored.

2. Description of the Related Art

Nowadays, with the spread of the Internet and mobile communication terminals, the traffic of communications that should be performed over existing networks to which a synchronous transfer mode is applied is increasing rapidly.

Therefore, in a higher-rank-stage node of such a network, line assignment suitable for a traffic distribution of incoming/outgoing lines is performed as appropriate through a cross-connect apparatus that performs cross-connect for each rate group such as OC-192.

FIG. 14 shows the configuration of an exemplary network that is provided with cross-connect apparatuses. As shown in FIG. 14, cross-connect apparatuses 140-u and 140-d are provided in an upstream link and a downstream link, respectively, between nodes 142-1 and 142-2 that are provided at two different networks 141-1 and 141-2.

The cross-connect apparatus 140-u is composed of the following components:

Optical-to-electrical converting parts (OR) 143-u1 to 143-un that are connected to n respective outgoing lines of the node 142-2.

Demultiplexing parts (DMUX) 144-u1 to 144-un that are disposed downstream of the respective optical-to-electrical converting parts 143-u1 to 143-un.

Cross-connect switches 145-u1 to 145-uk each of which has n inputs and that are connected to first to kth outputs, respectively, of each of the demultiplexing parts (DMUX) 144-u1 to 144-un.

Multiplexing parts (MUX) 146-u1 to 146-un that are connected to first to nth outputs, respectively, of each of the cross-connect switches 145-u1 to 145-uk.

Electrical-to-optical converting parts (OS) 147-u1 to 147-un that are disposed as final stages downstream of the respective multiplexing parts 146-u1 to 146-un.

The configuration of the other cross-connect apparatus 140-d is the same as that of the cross-connect apparatus 140-u and hence will not be described.

As shown in FIG. 15, the cross-connect switch 145-u1 is composed of the following components:

An OH dropping part 151-u1 and switch parts 150-u101 to 150-u116 that receive principal signals (for the sake of simplicity, it is assumed that each principal signal is a sequence of frames formed by multiplexing transmission information of 192 channels according to an STM scheme) in parallel from the demultiplexing parts (DMUX) 144-u1 to 144-un.

A processor 152 that controls operations of the cross-connect switches 145-u1 to 145-uk in a unified manner.

An address converting part 153-u1 that is connected to a corresponding port of the processor 152-u1 and has outputs that are connected to corresponding inputs of the switch parts 150-u101 to 150-u116, respectively.

The switch part 150-u101 is composed of the following components:

A TSW part 161-u101 that receives a principal signal (described above).

A selector 162-u101 having inputs that are connected to 16 respective read ports of 128 bits (for the sake of simplicity, it is assumed to be 16 bytes that are adjacent to each other, each byte being 8 bits) of the TSW part 161-u101.

An inserter 163-u101 that is disposed, as a final stage, downstream of the selector 162-u101.

A switch controlling part 164-u101 having an input that is connected to a corresponding output of the address converting part 153-u1 and outputs that are connected to control inputs of the TSW part 161-u101, the selector 162-u101, and the inserter 163-u101, respectively.

An ACM part 165-u101 that is a two-plane memory and operates under the switch controlling part 164-u101.

In the following description, for the sake of simplicity, it is assumed that the selector 162-u101 corresponds to a single destination to which a prescribed channel should be assigned by cross-connect. Further, the configurations of the other switch parts 150-u102 to 150-u116 are the same as the configuration of the switch part 150-u101 and hence will not be described.

The OH dropping part 151-u1 is composed of the following components:

A dropper 170-u1 that receives the principal signal.

A latch 171-u1 and a parallel-to-serial converting part 172-u1 that are cascade connected to each other and disposed downstream of the dropper 170-u1.

A PG part 173-u1 having outputs that are connected to control inputs of the dropper 170-u1, the latch 171-u1, and the parallel-to-serial converting part 172-u1, respectively.

The configurations of the other cross-connect switches 145-u2 to 145-uk are the same as the configuration of the cross-connect switch 145-u1 and hence will bot be described.

In the following description, for the sake of simplicity, an item that is common to the cross-connect switches 145-u1 to 145-uk will be described with its reference symbol not given neither the first suffix “u” nor a second suffix that is one of “1” to “k.” Further, an item that is common to the switch parts 150-u101 to 150-u116 will be described with its reference symbol not given none of the first suffix “u,” the second suffix “1”, and third and fourth suffixes that are one of “01” to “16.”

In the cross-connect apparatus 145 having the above configuration, the processor 152 gives a set of addresses to be used for realizing desired cross-connect to the address converting part 153 by playing a leading role or operating with a higher-rank apparatus (e.g., an exchange or a transmission apparatus that performs processing that relates to maintenance and operation).

The address converting part 153 generates an address sequence by performing processing that is suitable for the following items on such a set of addresses and supplies the generated address sequence to the switch controlling part 164:

The configurations of the TSW part 161 that operates as a time switch and the selector 162 that operates as a space switch that cooperates with the time switch.

Forms of load distribution and functional distribution among the address converting part 153, the switch controlling part 164, and the ACM part 165 in a process that the TSW part 161 and the selector 162 are accessed.

For the sake of simplicity, it is assumed that each address of such a set of addresses is formed by packing, according to a prescribed format, 16 read addresses to be supplied to the TSW part 161 and a selection signal to be supplied to the selector 162.

The switch controlling part 164 performs storage management (including reading and writing on the two planes alternately at frame periods) on the ACM part 165 and plays a leading role in accessing the ACM part 165 under frame synchronization with the principal signal, and thereby each address of the address sequence at a storage area that is determined under the above storage management.

Further, the switch controlling part 164 supplies, under the above-mentioned frame synchronization, the write port of the TSW part 161 with a write address sequence that is a sequence of cyclic serial numbers that are conform to the rate and the format of the principal signal.

As a result, pieces of transmission information that are the contents of the individual fields (time slots) of frames of the principal signal are stored repeatedly in storage areas of the TSW part 161 in order of addresses of the respective storage areas.

The switch controlling part 164 recognizes periods of the individual fields (time slots) of each frame under the above-mentioned frame synchronization. In those periods, the switch controlling part 164 supplies the read port of the TSW part 161 and the selection input of the selector part 162 with addresses that were stored in advance in corresponding storage areas of the ACM part 165.

In the following description, among such addresses, an address to be supplied to the read port of the TSW part 161 will be called “partial address” and an address to be supplied to the selection input of the selector part 162 will be called “selection address.”

The TSW part 161 outputs information of 128 bits (that is formed by packing 16 pieces of 8-bit transmission information that are adjacent to each other) that were written to a storage area indicated by the partial address among pieces of transmission information that were written in advance according to the above-mentioned write address sequence.

The selector 162 selects a single piece from the 16 pieces of information that is indicated by the selection address, and outputs a signal containing prescribed frames each of which contains a sequence of such single pieces of information.

The inserter 163 inserts information relating to maintenance of operation (e.g., UNEQ or an alarm indication information AIS) into fields that are specified by the switch controlling part 164 among the fields of each frame of such a signal, and thereby produces an output signal containing frames each of which is a sequence of fields (time slots) that should be sent to a desired destination.

In the OH dropping part 151, the dropper 170 extracts a field (time slot) that is specified by the PG part 173 and is known to contain overhead among the fields (time slots) of frames of the principal signal.

The latch 171 holds the contents of the thus-extracted field (time slot) under the control of the PG part 173. The parallel-to-serial converting part 172 converts the contents being held into a serial signal having a prescribed format and outputs the serial signal to the outside.

Incidentally, in the above conventional example, in the case where the multiplicity of a principal signal is so low that its rate is 80-110 Gbit/s or lower, desired cross-connect and flexible adaptation to the forms of maintenance and operation of transmission systems and networks can be attained by using existing circuit schemes, devices, and techniques relating to the mounting (layout) and wiring.

However, where the above-mentioned multiplicity is set at a larger value and the rate of a principal signal is 160 Gbit/s or higher, it is highly probable that realization of cross-connect is prevented by the following technical limitations or, even if realized, the hardware scale or the power consumption becomes unduly large:

In general, the hardware scale increases in proportion to the square of the multiplicity.

Even where the impedance of wiring is decreased to an extremity by formation of an LSI and other measures, the upper limit of the operation speeds of devices that constitute actual circuits is as low as about 78 MHz within the confines of allowable cost performance.

Theoretically, the limitation relating to the upper limit of operation speeds can be overcome by parallel processing. However, the number of signal lines and the number of pins that are necessary for realization of an LSI or a package increase as the word length for the parallel processing increases. As a result, strict restrictions are imposed on the pin layout and the thermal designing.

### SUMMARY OF THE INVENTION

An object of the present invention is to provide a cross-connect switch and a route monitoring assist apparatus that attain with reliability cross-connect of a much higher-speed interface at a low cost than in the conventional example, irrespective of the upper limit of operation speeds of devices.

Another object of the invention is to prevent increase in the numbers of wiring lines and pins and to substantially reduce limitations on the wiring, pin layout, and thermal designing owing to effective use of a multiport storage section without causing large increase in hardware size, even if the degree of multiplicity is high.

Another object of the invention is to attain multicast to desired destinations with reliability without changing the frequency (period) of access to the read ports of the multiport storage sections at all.

Another object of the invention is to simplify the configuration and attain multicast to desired destinations.

Another object of the invention is to standardize and simplify the configuration.

Another object of the invention is to increase the response speed and cooperate with other apparatuses in more various ways.

Another object of the invention is to use information, which is placed in a desired field of each frame, for maintenance and operation in a form adaptable to varieties of degrees of multiplicity and of frame structures.

Another object of the invention is to adapt to varieties of degrees of multiplicity and of frame structures.

Another object of the invention is to apply the invention to a transmission system in which multicast is performed, without unduly increasing the hardware scale.

Another object of the invention is to adapt to the structure of one or both of incoming lines and outgoing lines as well as traffic distribution and other conditions.

Still another object of the invention is to make it possible to cooperate with an apparatus not having a function that enables cooperation with the cross-connect switch of the invention.

Yet another object of the invention is to smoothly perform all of the monitoring, control, maintenance, and operation in proper form based on information that is placed in a desired field of each frame.

A further object of the invention is to adapt to high-speed-interface transmission sections at a low cost without lowering the total reliability of a transmission system or a network to which the invention is applied.

The invention provides a first cross-connect switch in which a high-speed-interface signal is written to a multiport memory cyclically and sequentially in units of a large word length and in which the signal is read from the multiport memory via a plurality of read ports in units of a word length that is shorter than the large word length. This makes it possible to attain cross-connect of a complete group, which is attained conventionally through a time switch and a space switch.

Even if the size of the multiport memory is set at a smaller value than the sum of the word lengths of pieces of time-division-multiplexed transmission information, this cross-connect switch can cross-connect at a low cost without causing any blocks because the larger the number of read ports of the multiport memory becomes, the larger the number of outgoing lines to be accommodated therein becomes.

The invention provides a second cross-connect switch in which data is written by random access and read sequentially and cyclically.

Even if the size of the multiport memory is set at a smaller value than the sum of the word lengths of pieces of time-division-multiplexed transmission information, this cross-connect switch can cross-connect at a low cost without causing any blocks because the larger the number of read ports of the multiport memory becomes, the larger the number of outgoing lines to be accommodated therein becomes.

The invention provides a third cross-connect switch which realizes multicast without the read rate set high, and with the number of multiport memories set equal to a maximum number of channels to which transmission information of a co-channel should be delivered.

With this cross-connect switch, it is able to deliver transmission information of a desired co-channel in parallel to destinations corresponding to respective read ports of the multiport memories without shortening the frequency at which data is read via those read ports.

The invention provides a fourth cross-connect switch which performs multicast and achieves a reduction in the number of multiport memories etc. to be incorporated.

With this cross-connect switch, each read port of multiport memories is accessed repeatedly at a frequency that is equal to a value obtained by dividing a write cycle by an integer, enabling a reduction in the number of multiport storage sections to be incorporated and delivery of transmission information of a desired co-channel in parallel to destinations corresponding to the read ports.

The invention provides a fifth cross-connect switch in which data is written to multiport memories by random access and is read sequentially and cyclically.

With this cross-connect switch, transmission information of a desired co-channel is delivered in parallel to destinations corresponding to respective read ports of the multiport memories without shortening the frequency at which data is read via those read ports.

The invention provides a sixth cross-connect switch in which data is written to multiport memories by random access and is read sequentially and cyclically.

With this cross-connect switch, each read port of the multiport storage sections is accessed repeatedly at a frequency that is equal to a value obtained by dividing a write cycle by an integer, thereby reducing the number of multiport storage sections to be incorporated and enabling delivery of transmission information of a desired co-channel in parallel to destinations corresponding to respective read ports.

The invention provides a seventh cross-connect switch in which UNEQ or other information is inserted collectively into desired fields (time slots) of each frame in a process of data read/data write from/to multiport memories.

This cross-connect switch makes it possible to decrease the hardware scale and the running cost irrespective of the degree of multiplicity, compared with the conventional example.

The invention provides an eighth cross-connect switch in which addresses used for accessing multiport memories in the process of inserting an UNEQ or other information are held in a holding memory in which addresses for realizing cross-connect are stored.

With this cross-connect switch, read addresses, which are supplied to the read ports of the multiport memories and enable placement of information in a desired channel, are stored in advance and then read out in order without being subjected to any special processing.

The invention provides a ninth cross-connect switch in which data is read via part or all of the read ports at a higher speed than data is written via all or part of the write ports to realize multicast.

With this cross-connect switch, multicast to a plurality of outgoing lines is attained with reliability without any increase in the number of planes of the multiport memory as long as the multiport memories and the holding memories are accessed.

The invention provides a 10th cross-connect switch that is different from the second cross-connect switch in that data is written by random access and read sequentially and cyclically.

With this cross-connect switch, multicast to a plurality of outgoing lines is attained with reliability without any increase in the number of planes of the multiport memory as long as the multiport memory and a holding memory are accessed and all the read ports of the multiport memory are required or allowed to serve for delivery of transmission information of a co-channel corresponding to destinations.

The invention provides an 11th cross-connect switch in which addresses to be stored in the storage areas of a holding memory can be set and updated in response to a request from exterior.

This cross-connect switch enables updating or setting of addresses to be supplied to the read ports or write ports of the multiport memories in cooperation with exterior, when necessary.

The invention provides a 12th cross-connect switch in which externally supplied addresses are converted into prescribed addresses, which are used for accessing the multiport memories.

With this cross-connect switch, a sequence of addresses necessary to realize cross-connect in a desired form is surely supplied and stored in a holding memory even if the addresses' format is different from a format of the externally supplied addresses.

The invention provides a first route monitoring assist apparatus in which a high-speed-interface signal is temporarily stored in multiport memories and then read therefrom via their read ports so that stored information on headers or the like, which are placed in prescribed fields of frames of the high-speed-interface signal, is extracted in order.

In this route monitoring assist apparatus, the storage section for storing data to be read therefrom/written thereto as described above performs all the processings including parallel-to-serial conversion that is performed in the conventional example; moreover, the hardware scale will not increase in proportion to an increase in the multiplicity irrespective of the frame structure and the degree of multiplicity.

The invention provides a second route monitoring assist apparatus that comprises a memory for holding read addresses for multiport memories and supplying those to the read ports thereof when appropriate.

With this route monitoring assist apparatus, information contained in desired fields of frames indicating transmission information of a plurality of channels is extracted in order with reliability during data readout/write from/to the multiport memories independent of the location of the information in the fields, as long as the read addresses are surely supplied from the exterior.

The invention provides a third route monitoring assist apparatus that converts information extracted via multiport memories into a prescribed message and informs it to the exterior.

This route monitoring assist apparatus passes the above information to an apparatus that refers to the information, in a suitable format for functional distribution and load distribution with the apparatus.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a first block diagram showing the principles of cross-connect switches according to the invention;

FIG. 2 is a second block diagram showing the principles of other cross-connect switches according to the invention;

FIG. 3 is a block diagram showing the principles of route monitoring assist apparatuses according to the invention;

FIG. 4 shows first, second, fourth, fifth, and seventh embodiments of the invention;

FIG. 5 is a time chart showing the operation of the first embodiment of the invention;

FIG. 6 shows a control address format;

FIG. 7 shows a configuration according to a modification of the first embodiment;

FIG. 8 shows a third embodiment of the invention;

FIG. 9 shows a control address format that is employed in the fourth embodiment of the invention;

FIG. 10 shows a sixth embodiment according to the invention;

FIGS. 11-13 show exemplary circuits that can replace a multiport memory;

FIG. 14 shows the configuration of an exemplary network that is provided with cross-connect apparatuses; and

FIG. 15 shows the configuration of an exemplary cross-connect apparatus.

### DESCRIPTION OF THE PREFERRED EMBODIMENTS

First, the principles of cross-connect switches and route monitoring assist apparatuses according to the present invention will be described.

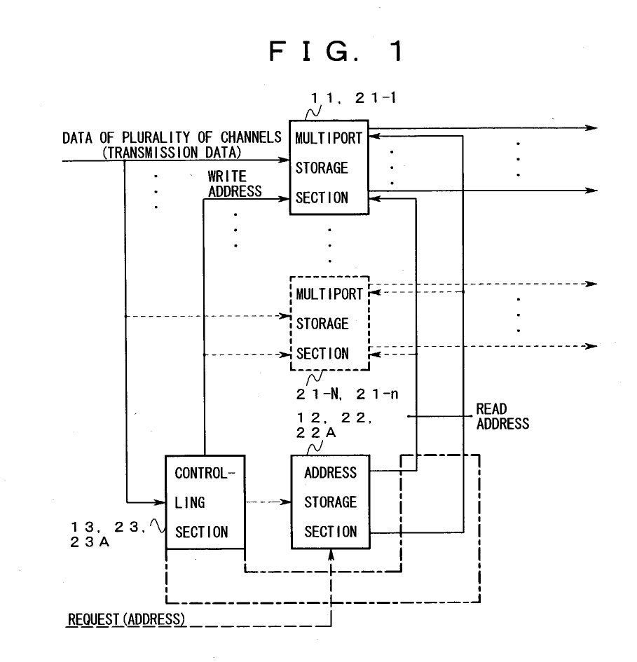

FIG. 1 is a first block diagram showing the principles of cross-connect switches according to the invention. Each cross-connect switch shown in FIG. 1 is composed of a multiport storage section 11 or multiport storage sections 21-1 to 21-N (or 21-n), an address storage section 12, 22, or 22A, and a controlling section 13, 23, or 23A.

The principle of a first cross-connect switch according to the invention is as follows.

The multiport storage section 11 has a plurality of read ports that are randomly accessible and a plurality of write ports to which data of a plurality of channels that are time-division-multiplexed are individually input in parallel in units of a word length that is plural times longer than a word length of the data. The address storage section 12 stores addresses to be supplied to the respective read ports. The controlling section 13 writes data in units of a plurality of channels by supplying write addresses sequentially to each of the write ports in synchronism with the channels, and supplies addresses stored in the address storage section 12 to the respective read ports.

That is, even if the size of the multiport storage section 11 is set at a smaller value than the sum of the word lengths of pieces of time-division-multiplexed transmission information, more outgoing lines can be accommodated as the number of read ports of the multiport storage section 11 increases. Cross-connect can be attained at a low cost without causing any blocks.

Effectively utilizing the multiport storage section 11, therefore, results in preventing an increase in the number of wiring lines and the number of pins and substantially reducing limitations on the wiring, pin layout, and thermal designing without causing large increase in hardware size, even when the degree of multiplicity is high.

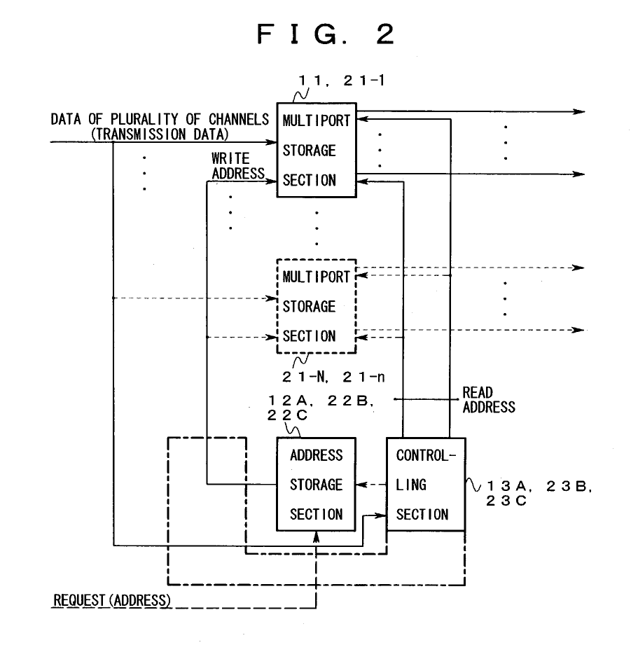

FIG. 2 is a second block diagram showing the principles of other cross-connect switches according to the invention. Each cross-connect switch shown in FIG. 2 is composed of a multiport storage section 11 or multiport storage sections 21-1 to 21-N (or 21-n), an address storage section 12A, 22B, or 22C, and a controlling section 13A, 23B, or 23C.

The principle of a second cross-connect switch according to the invention is as follows.

The multiport storage section 11 has a plurality of read ports that are randomly accessible and a plurality of write ports to which data of a plurality of channels that are time-division-multiplexed are individually input in parallel in units of a word length that is plural times longer than a word length of the data. The address storage section 12A stores addresses to be supplied to the write ports. The controlling section 13A read data in units of a plurality of channels by supplying read addresses sequentially to each of the read ports, and supplies addresses stored in the address storage section 12A to the respective write ports.

With this cross-connect switch, even if the size of the multiport storage section 11 is set smaller than the sum of the word lengths of pieces of transmission information that are time-division-multiplexed, more outgoing lines can be accommodated as the number of read ports of the multiport storage section 11 increases. Cross-connect can be attained at a low cost without causing any blocks.

Effectively utilizing the multiport storage section 11, therefore, results in preventing an increase in the number of wiring lines and the number of pins and substantially reducing limitations on the wiring, pin layout, and thermal designing without causing large increase in hardware size, even when the degree of multiplicity is high.

The principle of a third cross-connect switch according to the invention is as follows.

Referring to FIG. 1, a plural number n of multiport storage sections 21-1 to 21-N have respective read ports that are randomly accessible and respective write ports to which data of a plurality of channels that are time-division-multiplexed are individually input in parallel in units of a word length that is plural times longer than a word length of the data, n being equal to a maximum number N of channels to which data of a co-channel should be delivered. The address storage section 22 stores addresses to be supplied to the read ports. The controlling section 23 writes data in units of a plurality of channels by supplying write addresses sequentially to each of the write ports, and supplies addresses stored in the address storage section 22 to the read ports of the multiport storage sections 21-1 to 21-N.

With this cross-connect switch, transmission information of a desired co-channel is delivered in parallel to destinations corresponding to respective read ports of the multiport storage sections 21-1 to 21-N without shortening the frequency of reading via those read ports.

Therefore, multicast to desired destinations is attained with reliability without changing the frequency (period) of access to the read ports of the multiport storage sections 21-1 to 21-N at all as long as the number n of multiport storage sections 21-1 to 21-N to be incorporated is allowably small and set greater than or equal to the number of channels to which data of a co-channel should be delivered.

The principle of a fourth cross-connect switch according to the invention is as follows.

Referring to FIG. 1, a plural number n of multiport storage sections 21-1 to 21-n have respective read ports that are randomly accessible and respective write ports to which data of a plurality of channels that are time-division-multiplexed are individually input in parallel in units of a word length that is plural times longer than a word length of the data, n being smaller than a maximum number N of channels to which data of a co-channel should be delivered. The address storage section 22A stores addresses to be supplied to the read ports. The controlling section 23A writes data in units of a plurality of channels by supplying write addresses sequentially to the write ports, and for supplying addresses stored in the address storage section 22A to the read ports at a frequency that is equal to or smaller than a quotient of a frequency at which write addresses are updated and a ratio of the maximum number N to the plural number n.

With this cross-connect switch, each read port of the multiport storage sections 21-1 to 21-n is accessed repeatedly at a frequency that is equal to a value obtained by dividing a write cycle by an integer, whereby the number of multiport storage sections 21-1 to 21-n to be incorporated is reduced and transmission information of a desired co-channel is delivered in parallel to destinations corresponding to respective read ports.

Therefore, access times of the multiport storage sections 21-1 to 21-n are utilized effectively, simplifying the configuration and attaining reliable multicast to desired destinations.

The principle of a fifth cross-connect switch according to the invention is as follows.

Referring to FIG. 2, a plural number n of multiport storage sections 21-1 to 21-N have respective read ports that are randomly accessible and respective write ports to which data of a plurality of channels that are time-division-multiplexed are individually input in parallel in units of a word length that is plural times longer than a word length of the data, n being equal to a maximum number N of channels to which data of a co-channel should be delivered. The address storage section 22B stores addresses to be supplied to the write ports. The controlling section 23B reads data in units of a plurality of channels by supplying read addresses sequentially to each of the read ports, and supplies addresses stored in the address storage section 22B to the write ports of the multiport storage sections 21-1 to 21-N.

With this cross-connect switch, transmission information of a desired co-channel is delivered in parallel to destinations corresponding to respective read ports of the multiport storage sections 21-1 to 21-N without shortening the frequency at which data is read via those read ports.

Therefore, multicast to desired destinations is attained with high reliability without changing the frequency (period) of access to the read ports of the multiport storage sections 21-1 to 21-N at all as long as the number n of multiport storage sections 21-1 to 21-N to be incorporated is allowably small and set greater than or equal to the number of channels to which data of a co-channel should be delivered.

The principle of a sixth cross-connect switch according to the invention is as follows.

Referring to FIG. 2, a plural number n of multiport storage sections 21-1 to 21-n have respective read ports that are randomly accessible and respective write ports to which data of a plurality of channels that are time-division-multiplexed are individually input in parallel in units of a word length that is plural times longer than a word length of the data, n being smaller than a maximum number N of channels to which data of a co-channel should be delivered. The address storage section 22C stores addresses to be supplied to the write ports. The controlling section 23C reads data in units of a plurality of channels by supplying read addresses sequentially to each of the read ports, and for supplying addresses stored in the address storage section 22C to the write ports at a frequency which is equal to or smaller than a quotient of a frequency at which read addresses are updated and a ratio of the maximum number N to the plural number n.

With this cross-connect switch, each read port of the multiport storage sections 21-1 to 21-n is accessed repeatedly at a frequency that is equal to a value obtained by dividing a write cycle by an integer, whereby the number of multiport storage sections 21-1 to 21-n to be incorporated is reduced and transmission information of a desired co-channel is delivered in parallel to destinations corresponding to respective read ports.

Therefore, access times of the multiport storage sections 21-1 to 21-n are utilized effectively, thereby simplifying the configuration and attaining reliable multicast to desired destinations.

The principle of a seventh cross-connect switch according to the invention is as follows.

The multiport storage section 11 or the multiport storage section 21-1 to 21-N or 21-1 to 21-n have storage areas for storing data different from the data of the plurality of channels that are time-division-multiplexed. The controlling section 13, 13A, 23, 23A, 23B, or 23C supplies addresses of storage areas where the different data are stored to the read ports of the multiport storage section 11 or the multiport storage section 21-1 to 21-N or 21-1 to 21-n.

With this cross-connect switch, the hardware scale and the running cost are decreased irrespective of the degree of multiplicity compared with the conventional example, which having dedicated hardware that enables placement of different data corresponding to a desired channel.

Therefore, the configuration is standardized and simplified.

The principle of an eighth cross-connect switch according to the invention is as follows.

Part of words to be written to all or part of the storage areas of the multiport storage section 11 or the multiport storage section 21-1 to 21-N or 21-1 to 21-n include information relating to one or both of maintenance and operation. Addresses of the storage areas of the multiport storage section 11 or the multiport storage section 21-1 to 21-N or 21-1 to 21-n where the information is stored are stored in part of the storage areas of the address storage section 12, 12A, 22, 22A, 22B, or 22C that are to be read in cooperation with the controlling section 13, 13A, 23, 23A, 23B, or 23C, at a prescribed instance suitable for a frame structure that is employed in the time division multiplexing of the channels.

With this cross-connect switch, read addresses, which are supplied to the read ports of the multiport storage section 11 or the multiport storage section 21-1 to 21-N or 21-1 to 21-n and enable placement of the above information in a desired channel, are stored in advance in the address storage section 12, 12A, 22, 22A, 22B, or 22C and then read out in order without being subjected to any special processing by the controlling section 13, 13A, 23, 23A, 23B, or 23C.

Therefore, as in the case of the seventh cross-connect switch, the hardware scale and the running cost are reduced irrespective of the degree of multiplicity. The configuration is further simplified than in the seventh cross-connect switch.

The principle of a ninth cross-connect switch according to the invention is as follows.

The controlling section 13 supplies a sequence of addresses stored in said address storage section 12 to all or part of the read ports at a frequency that is shorter than or equal to a ratio, which is a ratio of a frequency at which write addresses are updated to a maximum number of channels to which transmission information of a co-channel is to be delivered during the process of cross-connect.

With this cross-connect switch, multicast to a plurality of outgoing lines is realized with reliability without any increase in the number of planes of the multiport storage section 11 as long as the multiport storage section 11 and the address storage section 12 are accessed.

This allows the invention to be applied to a transmission system in which multicast is performed, without unduly increasing the hardware scale.

The principle of a 10th cross-connect switch according to the invention is as follows.

The controlling section 13A supplies write addresses sequentially to all or part of the read ports at a frequency that is shorter than or equal to a ratio of a frequency at which write addresses are updated to a maximum number of channels to which transmission information of a co-channel is to be delivered during the process of cross-connect.

With this cross-connect switch, multicast to a plurality of outgoing lines is realized with reliability without any increase in the number of planes of the multiport storage section 11 as long as the multiport storage section 11 and the address storage section 12A are accessed reliably and all the read ports of the multiport storage section 11 are required or allowed to serve for delivery of transmission of a co-channel to corresponding destinations.

This allows the invention to be applied to a transmission system in which multicast is performed, without unduly increasing the hardware scale.

The principle of an 11th cross-connect switch according to the invention is as follows.

The address storage section 12, 12A, 22, 22A, 22B, or 22C comprises a section that enables updating of addresses to be stored in the storage areas of the address storage section 12, 12A, 22, 22A, 22B, or 22C in response to a request from exterior.

With this cross-connect switch, addresses to be supplied to the read ports or write ports of the multiport storage section 11 or the multiport storage sections 21-1 to 21-N or 21-1 to 21-n are set and updated as appropriate in cooperation with the exterior.

This enables flexible adaptation to the structure of one or both of incoming lines and outgoing lines as well as traffic distribution and other conditions.

The principle of a 12th cross-connect switch according to the invention is as follows.

The address storage section 12, 12A, 22, 22A, 22B, or 22C converts a format of externally supplied addresses into a format conforming to a sequence of the addresses and stores a conversion result in corresponding storage areas.

With this cross-connect switch, a sequence of addresses necessary to realize cross-connect of a desired form is supplied with reliability even if their format is different from that of the externally supplied addresses, and the sequence of addresses is stored in the address storage section 12, 12A, 22, 22A, 22B, or 22C.

This makes it possible to cooperate with an apparatus that is not provided with a function that enables cooperation with the 12th cross-connect switch.

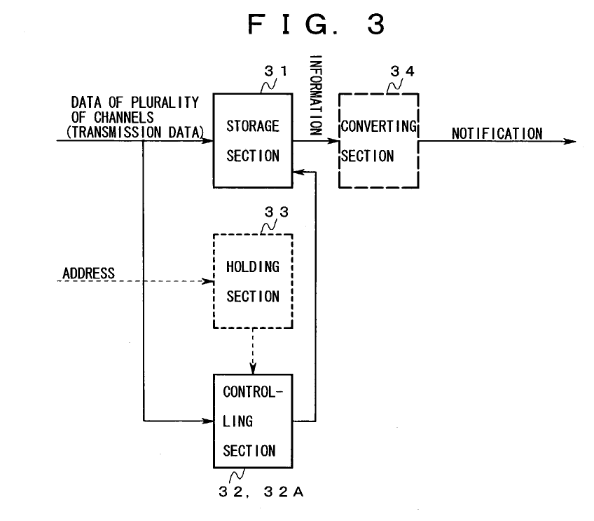

FIG. 3 is a block diagram showing the principles of route monitoring assist apparatuses according to the invention. Each route monitoring assist apparatus shown in FIG. 3 is composed of a storage section 31, a controlling section 32 or 32A, a holding section 33, and a converting section 34.

The principle of a first route monitoring assist apparatus according to the invention is as follows.

The storage section 31 cyclically holds pieces of transmission information of a plurality of channels that are time-division-multiplexed, in units of a word having a length that is plural times longer than that of the pieces of transmission information. The storage section 31 are randomly accessible and has read ports that have a word length shorter than that of write ports. The controlling section 32 generates, in synchronism with the channels, addresses of part of the storage areas of the storage section 31 where information contained in desired fields of frames indicating the pieces of transmission information of the channels is held, and supplies the addresses to the read ports.

In this route monitoring assist apparatus, the storage section 31 for storing data to be read therefrom/write thereto as above collectively performs the processings including parallel-to-serial conversion that is performed in the conventional example; moreover, the hardware scale will not increase in proportion to an increase in the multiplicity irrespective of the frame structure and the degree of multiplicity.

Therefore, the above information is surely used for maintenance and operation in a form adapting to varieties of degrees of multiplicity and of frame structures.

The principle of a second route monitoring assist apparatus according to the invention is as follows.

The storage section 31 cyclically holds pieces of transmission information of a plurality of channels that are time-division-multiplexed, in units of a word having a word length that is plural times longer than that of the pieces of transmission information, and it has read ports that have a word length that is shorter than that of write ports and are randomly accessible. The holding section 33 holds externally supplied addresses of part of the storage areas of the storage section 31 where information contained in desired fields of frames indicating the pieces of transmission information of the channels is held. The controlling section 32A supplies the addresses held by the holding section 33 to the read ports in synchronism with the channels.

In this route monitoring assist apparatus, the above information is extracted in order with reliability as long as addresses as described above are supplied externally in a proper manner irrespective of the location of the information in fields of frames.

This enables more flexible adaptation to varieties of degrees of multiplicity and frame structures than the first route monitoring assist apparatus does.

The principle of a third route monitoring assist apparatus according to the invention is as follows.

The converting section 34 informs, to an outside system, in a prescribed format, a sequence of pieces of information that are read from the storage section 31 via the read ports.

In this route monitoring assist apparatus, the above pieces of information are passed to an apparatus that refers to those pieces of information, in a suitable format for functional distribution and load distribution with the apparatus.

In a transmission system to which the invention is applied, therefore, all of the monitoring, control, maintenance, and operation are smoothly performed in proper form based on the above information.

Embodiments of the present invention will be hereinafter described in detail with reference to the drawings.

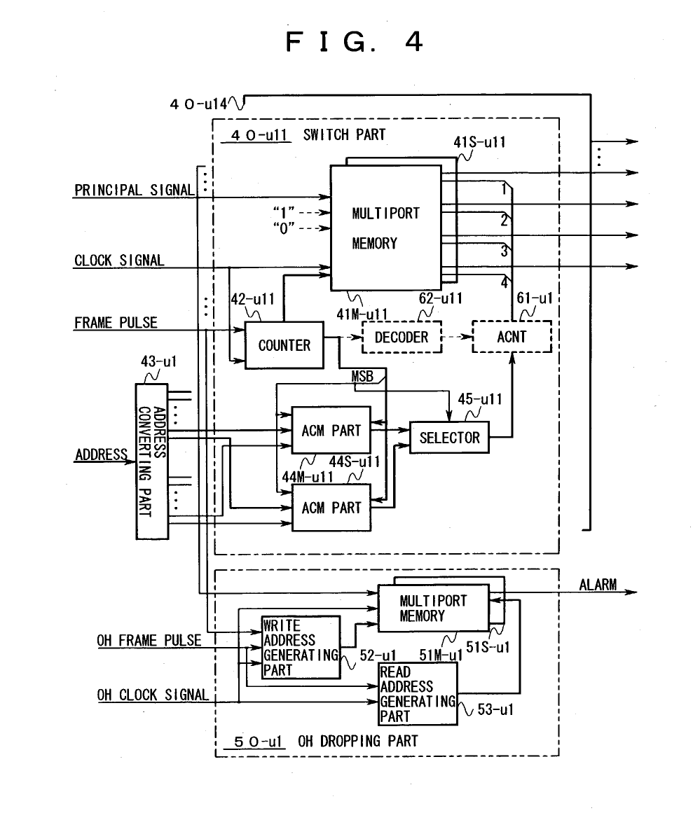

FIG. 4 shows first, second, fourth, fifth, and seventh embodiments of the invention, which have the following features:

A signal obtained by converting a high-speed-interface principal signal that is a sequence of pieces of transmission information of 3,072 channels that are multiplexed according to an STM scheme and is given at a rate of 160 Gbit/s into a sequence of words of 128 bits is received as a principal signal.

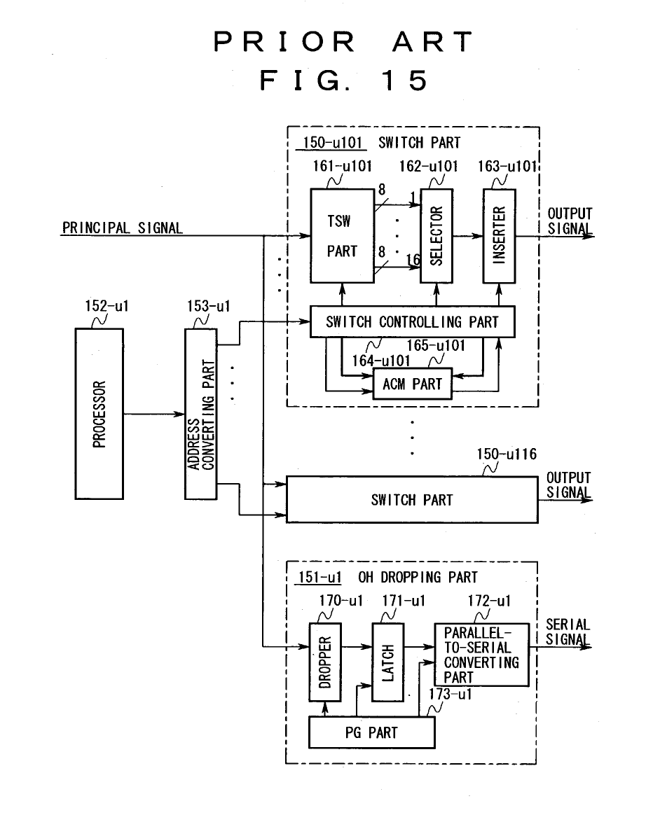

The configuration of four switch parts 40-u11 to 40-u14 that are provided in place of the switch parts 150-u101 to 150-u116 as shown in FIG. 15 and conform to such a high-speed-interface principal signal.

In the following description, for the sake of simplicity, an item that is common to the switch parts 40-u11 to 40-u14 will be described with its reference symbol not given first to third suffixes that are one of “u11” to “u14.”

The switch part 40 is composed of the following components:

Two multiport memories 41M and 41S each of which has storage areas for 24 words whose word length is equal to the word length of a high-speed-interface principal signal divided by an integer (for the sake of simplicity, it is assumed to be 128 bits), a single write port that receives a high-speed-interface principal signal and is used for word-by-word writing, and four read ports that has an 8-bit word length and correspond to four respective destinations.

A counter 42 that receives frame pulses that are synchronized with frames of a high-speed-interface principal signal and a clock signal indicating a start point (or an end point) of sets of 16 (=128 bits/8 bits (the word length of a time slot per unit channel)) fields (time slots) that are adjacent to each other and located in each frame. One input of the counter 42 is connected to the address input of the write port of each multiport memory 41.

Two ACM parts 44M and 44S that operate as a two-plane memory of 52 (>(log₂3072+1)×4). The write port of each of the ACM parts 44M and 44S is connected to a data output and an address output of an address converting part 43 that replaces the address converting part 153 shown in FIG. 115. The address input of the read port of each of the ACM parts 44M and 44S is connected to the other output of the counter 42 (low-order bits (i.e., the MSB is excluded) are received). The two ACM parts 44M and 44S are write-permitted alternatively in accordance with the logical value of the MSB.

A selector 45 having two inputs that are connected to the data outputs of the read ports of the ACM parts 44M and 44S, respectively, a selection input that is connected to the other output of the counter 42 (the MSB is received), and an output that is connected to the address inputs of corresponding read ports of each of the multiport memories 41M and 41S (lower 9 (>log₂(16.24)) bits of each of four sets of 13 (=52/4) bits obtained by equally dividing an output address into four parts are supplied).

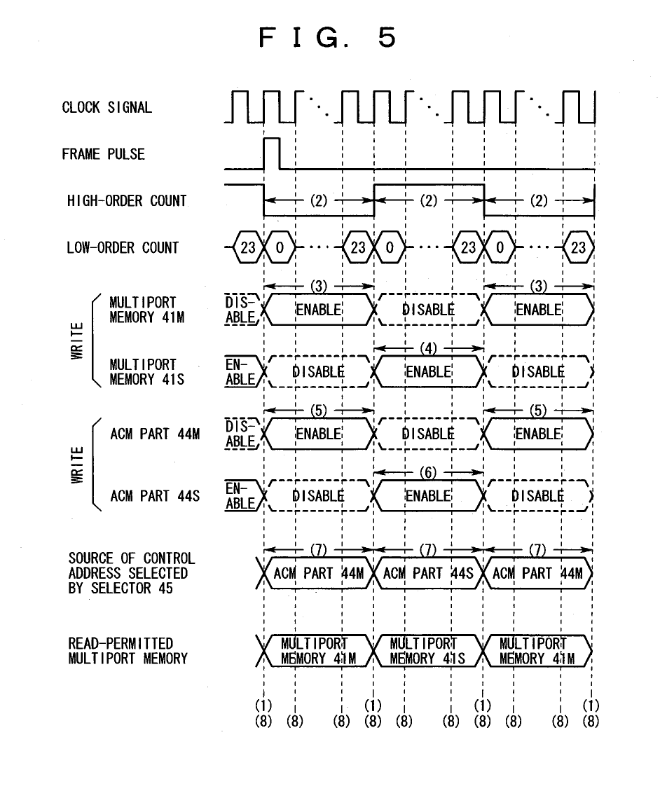

FIG. 5 is a time chart showing the operation of the first embodiment of the invention. The operation of the first embodiment of the invention will be described below with reference to FIGS. 4 and 5.

The counter 42 is composed of a 5-bit, 32-scale (32>24) counter (hereinafter referred to as “low-order counter) that is reset by the rising edge (or trailing edge) of each frame pulse (indicated by symbol (1) in FIG. 5) and a binary counter (hereinafter referred to as “high-order counter”) that counts an overflow portion of the low-order counter. Therefore, the low-order counter counts pulses of the clock signal and outputs a resulting count (one of “00” to “23”) cyclically (indicated by symbol (2) in FIG. 5). In the following description, the counts of the high-order counter and the low-order counter will be referred to as “high-order count” and “low-order count,” respectively.

The multiport memories 41M and 41S are write-permitted only during periods when the high-order count is equal to “0” and “1,” respectively (indicated by symbols (3) and (4) in FIG. 5). And 128-bit words of a principle signal are cyclically written to the first to 24th storage areas (indicated by the low-order address that is given by the low-order counter) of one of the multiport memories 41M and 41S that is indicated by the high-order count.

Therefore, although the maximum number of words that can be stored in the multiport memories 41M and 41S is ⅛ (3,072 channels/16 channels/24 words) of the number of fields (multiplexed time slots) of each frame, the contents of a field (time slot) at any position in each frame are stored in a fixed storage area of the multiport memories 41M and 41S.

Writing, to the ACM parts 44M and 44S, of control addresses that are supplied through the address converting part 43 are permitted alternately according to the high-order count (indicated by symbols (5) and (6) in FIG. 5).

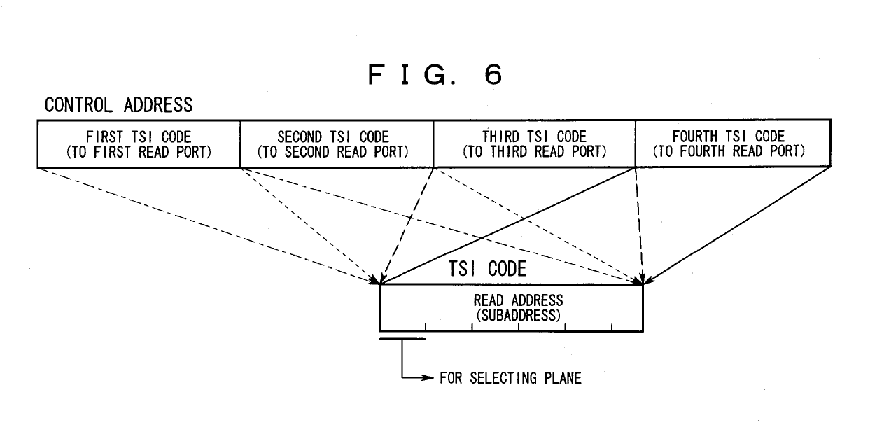

Incidentally, as shown in FIG. 6, each control address is a word that satisfies the following conditions and is supplied from the outside to the ACM part 44M (or 44S) through the address converting part 43:

Each control address has four fields that correspond to the four respective read ports of each of the multiport memories 41M and 41S.

The four fields contain respective prescribed addresses (it is assumed that they indicate, among the storage areas of the multiport memory 41M (or 41S), storage areas where pieces of transmission information of desired channels that should be directed to destinations corresponding to the respective fields are stored; for the sake of simplicity, they will be called “TSI codes”).

The low-order count is supplied to the read ports of the respective ACM parts 44M and 44S in parallel as a read address. The selector 45 chooses, from control addresses that are read from those read ports in accordance with the read address, the control address that is read from the read port of one of the ACM parts 44M and 44S that is not write-permitted (indicated by symbol (7) in FIG. 5).

Further, the selector 45 adds, as the MSB, binary information that is equal to the high-order count to the sub addresses that are contained in the four fields of the selected control address (indicated by symbol (8) in FIG. 5).

Therefore, the four TSI codes that have been selected in the above manner and to which the binary information has been added are supplied, as read addresses, to the four read ports of each of the multiport memories 41M and 41S.

Reading from the multiport memories 41M and 41S via the read ports is permitted only during periods when the MSB of the read addresses that are supplied to the read ports has values “1” and “0,” respectively. That is, writing to the multiport memories 41M and 41S via the respective write ports is permitted alternately and reading from the multiport memories 41M and 41S via the read ports is also permitted alternately in which a write-permitted multiport memory is always different from a read-permitted one.

The multiport memories 41M and 41S are accessed alternately and repeatedly at unit frame periods by a prescribed plural number of times and can collectively perform the pieces of processing that are performed by the TSW part 161 and the selector 162 as shown in FIG. 15, even in the case where the multiplicity of a principal signal is much higher than in the conventional example as long as write addresses and read addresses are supplied reliably.

The individual parts of the switch parts 40-u12 to 40-u14 cooperate with each other in parallel in accordance with principal signals that are supplied to the switch parts 40-u12 to 40-u14 in parallel.

Although the amount of information that can be held by the multiport memories 41M and 41S is much smaller than that of each frame of a principal signal, the number of outgoing lines that a single switch part 40 can accommodate increases as the number of read ports of each of the multiport memories 41M and 41S increases.

Therefore, according to this embodiment, multiport memories 41M and 41S are effectively accessed alternately and repeatedly, whereby the following items are attained and a cross-connect switch of a complete group can be realized at a low cost in a stable manner:

Even if the degree of multiplicity increases, the hardware size can be prevented from increasing to a large extent within the upper limit of the operation speeds of usable devices.

Not only increase in the number of signal lines and the number of pins that are necessary for realization of an LSI or a package but also restrictions on the pin layout and the thermal designing are reduced to a large extent. Further, the degree of freedom relating to mounting (e.g., a layout in an ASIC) is increased.

In this embodiment, pieces of transmission information fields (channels) multiplexed on each frame are subjected to cross-connect in octets by the switch parts 40-1 to 40-4.

However, in the invention, cross-connect may be performed in bits by a configuration that is different from the configuration of the above embodiment in the following points, for example, so that flexible adaptation is made to a frame structure in which fields or channels having different word lengths are multiplexed:

(a) Instead of the above-described clock signal, a clock signal indicating start points (or end points) of respective fields (time slots) in each frame is supplied to the counter 42.

(b) The word lengths of four TSI codes that are packed in a control address are fixed to 13 (>log₂3072+1) and the lower 12 (>log₂3072) bits of each TSI code are supplied to the address input of a read port corresponding to 41M, 41S.

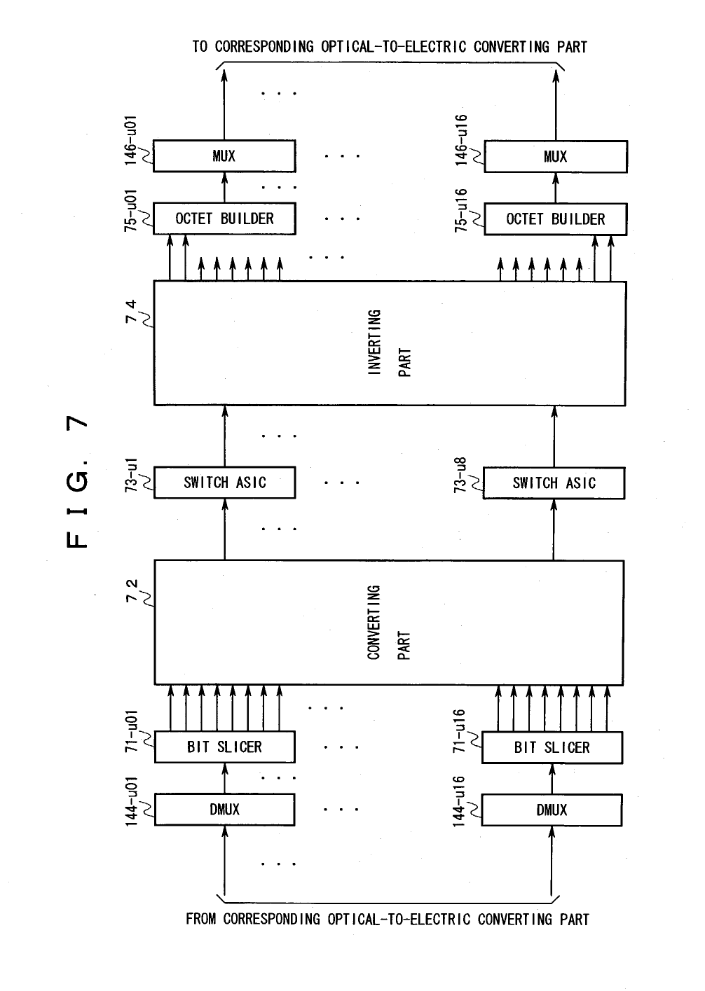

(c) The following components shown in FIG. 7 are provided:

Bit slicers 71-u01 to 71-u16 that are disposed downstream of the respective demultiplexing parts 144-u01 to 144-u16 and decompose octets (mentioned above) into bits in parallel.

A converting part 72 that multiplexes, in the time domain, one by one, 8-bit outputs of the respective bit slicers 71-u01 to 71-u16. (The converting part 72 may be distributed to all or part of a back board that is provided on the back side of a bay or a shelf and realizes connections between ASICs and packages, the bit slicers 71-u01 to 71-u16, and switch ASICs 72-u1 to 72-u8 (described later).)

Switch ASICs 73-u1 to 73-u8 that are connected to the eight outputs (corresponding to the respective bits) of the converting part 72 and is different than in the first embodiment in items (a) and (b).

Inverting parts 74 that is disposed downstream of the switch ASICs 73-u1 to 73-u8 and performs processing that is reverse to the processing that is performed by the converting part 72. (The inverting part 74 may be distributed to all or part of the above-mentioned back board, the switch ASICs 73-u1 to 73-u8, and octet builders 75-u01 to 75-u16 (described later).)

Octet builders 75-u01 to 75-u16 that are disposed between the inverting part 74 and the demultiplexers 144-u01 to 144-u16 and performs processing that is reverse to the processing that is performed by the bit slicers 71-u01 to 71-u16.

The second embodiment of the invention will be hereinafter described.

In this embodiment, the period of a clock signal that is supplied to the counter 42 is set at the corresponding period in the first embodiment divided by an integer K (for the sake of simplicity, it is assumed to be a power of 2). The number of bits of the counter 42 (low-order counter) is set at a value that is greater than the corresponding number in the first embodiment by log₂K bits. A high-order count excluding low-order log₂K bits (including the LSB) of a low-order count that is obtained by the counter 42 is supplied, as a write address, to the write ports of the respective multiport memories 41M and 41S. The number of storage areas of the ACM parts 44M and 44S is set at the product of the corresponding number in the first embodiment and the integer K. All the bits of the above-mentioned low-order count are supplied, as a read address, to the read ports of the respective ACM parts 44M and 44S.

The operation of the second embodiment of the invention will be described below with reference to FIG. 4.

A control address to be stored in the ACM parts 44M and 44S has four fields as in the case of the first embodiment. However, common addresses that correspond to respective destinations to which transmission information of a desired one of fields (time slots) that are multiplexed in a principal signal (frames) should be delivered and indicate the desired field (time slot) are set as sub addresses (mentioned above) as appropriate.

The word length and the format of such TSI codes are the same as in the first embodiment unless the word length, the number of words, and other particulars of the multiport memories 41M and 41S remain the same, and hence will not be described.

This embodiment is different from the first embodiment in the following points. Since the period of the clock signal that is supplied to the counter 42 is set at the corresponding period in the first embodiment divided by the integer K, the period of reading to be performed on the multiport memories 41M and 41S via their read ports is also set at the corresponding period in the first embodiment divided by the integer K. The word length of read addresses that are supplied to the read ports of the ACM parts 44M and 44S increases by log₂K.

Therefore, in this embodiment, multicast to a maximum of K destinations is attained reliably for any of fields (time slots) that are multiplexed in a principal signal (fields) as long as the period of reading from the multiport memories 41M and 41S via their read ports can be shortened.

In this embodiment, to realize the above-mentioned multicast, the period of reading from the multiport memories 41M and 41S via their read ports is set shorter than in the first embodiment. However, the invention may be used not only for realizing such multicast but also for decreasing the number of necessary switch parts 40 as long as, for example, desired processing is performed downstream of the switch parts 40 or proper rate conversion is performed.

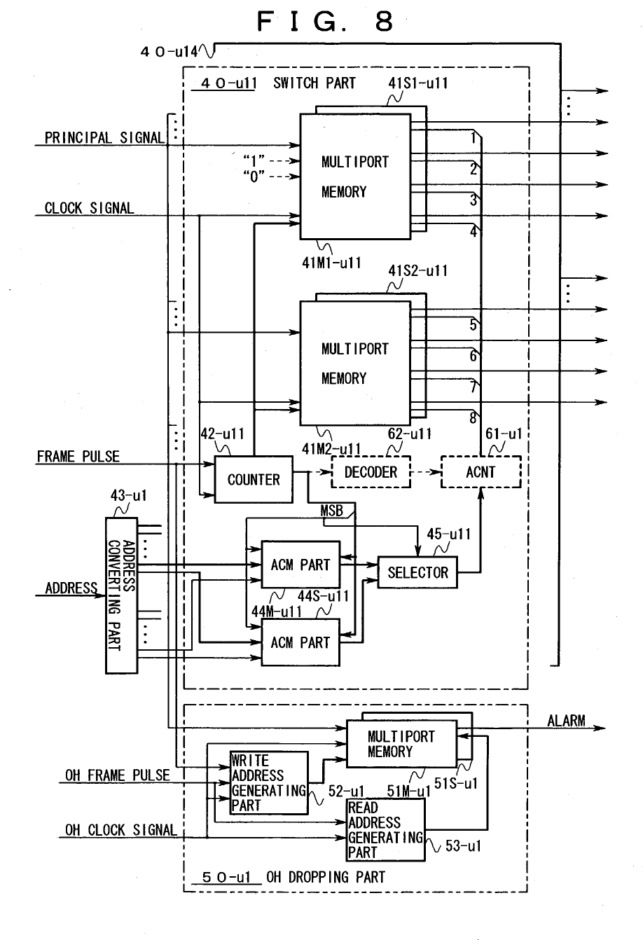

FIG. 8 shows a third embodiment of the invention.

In this embodiment, the above-described multiport memories 41M and 41S are replaced by K (integer; for the sake of simplicity, it is assumed to be “2”) multiport memories 41M1 and 41M2 and K multiport memories 41S1 and 41S2, respectively. The period and the number of bits of a clock signal supplied to the counter 42 are the same as in the first embodiment. A low-order count that is obtained by the counter 42 is supplied, as a common write address, to the write ports of the respective multiport memories 41M1, 41M2, 41S1, and 41S2.

The number of storage areas of the ACM parts 44M and 44S is the same as in the first embodiment. The word length of the storage areas of the ACM parts 44M and 44S is set two (=K) times that in the first embodiment.

The operation of the third embodiment will be described below with reference to FIG. 8.

A control address to be stored in the ACM parts 44M and 44S has four fields (hereinafter referred to as “first to fourth fields”) similar to those in the first embodiment plus fifth to eighth fields.

TSI codes similar to those in the first embodiment are set in the first to fourth fields among the first to eighth fields.

TSI codes that are peculiar in the following points are set as appropriate in the fifth to eighth fields:

Correspond to transmission information to be read from the first to fourth read ports of the multiport memories 41M2 and 41S2 among transmission information of desired fields (time slots) that are multiplexed in a principal signal (frame).

Correspond to other destinations that are different from destinations corresponding to the first to fourth read ports of the multiport memories 41M1 and 41S1 and only transmission information that should be delivered to the other destinations in parallel (multicast).

The word length and the format of such TSI codes are assumed to be the same as in the first embodiment for the sake of simplicity, and hence will not be described.

The period of a clock signal that is supplied to the counter 42 and the word length of a read address that is supplied from the counter 42 (low-order counter) to the read ports of the ACM parts 44M and 44S are the same as in the first embodiment.

The selector 45 performs the same processing as in the first embodiment on first to eighth TSI codes that are included in each control address that is read via the read ports of the ACM parts 44M and 44S, and supplies, in parallel, individual first to fourth TSI codes and individual fifth to eighth TSI codes that have been obtained as a result of the above processing to the multiport memories 41M1 and 41S1 and the multiport memories 41M2 and 41S2, respectively.

Therefore, in this embodiment, the period of reading via all the read ports of the multiport memories 41M1, 41M2, 41S1, and 41S2 is kept the same as in the first embodiment (i.e., not shortened) and multicast to K (integer) destinations can be performed reliably for any of fields (time slots) that are multiplexed in a principal signal (frame).

In this embodiment, the maximum number of destinations to which common transmission information should be delivered in parallel is set at 2 that is equal to the integer K.

However, the invention can be implemented irrespective of the integer K as long as multiport memories are provided in a number that is proportional to the integer K and the word length of the storage areas of the ACM parts 44M and 44S is set at a value that is proportional to the total number of multiport memories.

In this embodiment, a plurality of multiport memories corresponding to respective destinations to which common transmission information should be delivered in parallel are provided.

However, the invention is not limited to such a configuration. For example, this embodiment may be combined with the second embodiment so that the number of switch parts 40 to be provided and the power consumption are reduced and flexible adaptation is made to a desired frame structure and a form of transmission within restrictions relating to wiring, mounting, thermal designing, etc. in the case where the maximum number of destinations is large.

In the first to third embodiments, a write address that is updated sequentially and cyclically is supplied to the write ports of the multiport memories 41M, 41M1, 41M2, 41S, 41S1, and 41S2 and the read ports of the multiport memories 41M, 41M1, 41M2, 41S, 41S1, and 41S2 are supplied, by random access, with read addresses from the read ports of the ACM parts 44M and 44S through the selector 45.

However, the invention is not limited to such a case. For example, in one of the following cases, read addresses for the multiport memories 41M, 41M1, 41M2, 41S, 41S1, and 41S2 may be updated sequentially and cyclically and a write address may be supplied to the multiport memories 41M, 41M1, 41M2, 41S, 41S1, and 41S2 by random access:

A case that only one of the four read ports of the multiport memories 41M, 41M1, 41M2, 41S, 41S1, and 41S2 is connected to a transmission channel that leads to an effective destination.

A case that transmission information of a desired one of fields (time slots) that are multiplexed in a principal signal (frame) should be directed in parallel (multicast) to all destinations corresponding to the four read ports of the multiport memories 41M, 41M1, 41M2, 41S, 41S1, and 41S2.

The fourth embodiment of the invention will be hereinafter described.

This embodiment is characterized by the following points that are indicated by broken lines in FIG. 4:

The word length of the write ports of the multiport memories 41M and 41S is set at 130 bits. Different logical values “0” and “1” are input constantly as the highest two bits (including the MSB) of the 130 bits. A principal signal is input as the lower 128 bits of the 130 bits in the same manner as in the first embodiment.

An address controlling part (ACNT) 61 is additionally disposed between the output of the selector 45 and the four read ports of the multiport memories 41M and 41S.

A decoder 62 is added that is connected to the count output of the counter 42 and the control input of the address controlling part 61.

The operation of the fourth embodiment of the invention will be described below with reference to FIG. 4.

Pieces of transmission information that are multiplexed in bits rather than in octets are supplied, as a principal signal, to the write ports of the multiport memories 41M and 41S as the same are supplied to, for example, the switch ASIC 73-u1 shown in FIG. 7.

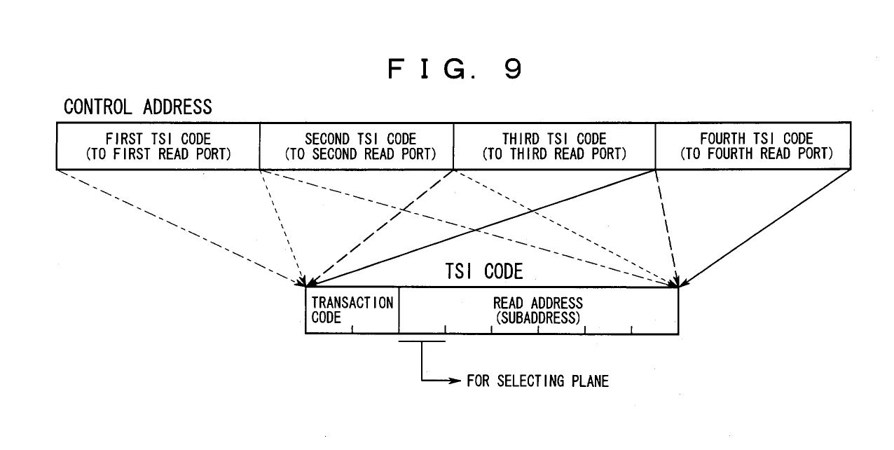

As shown in FIG. 9, TSI codes that are different from those contained in the control address shown in FIG. 6 in that a 2-bit transaction code indicating one of the following forms of processes to be executed by the address controlling part 61 is added at the highest two bits including the MSB are contained in an control address that is supplied from the ACM parts 44M and 44S to the address controlling part 61 through the selector 45:

(a) Transaction code=“01”: A process-1 to be executed to set, in four fields (time slots; hereinafter referred to as “control fields”) containing prescribed overhead, a sequence of words including an externally set bit string “SS” (for the sake of simplicity, it is assumed that the word length is 2 bits) that are “0110SS00,” “00H,” “00H,” and “00H” (UNEQ indicating a state that mounting of a resource indicated by the bit string “SS” is cancelled; hereinafter referred to as “first specific words”).

(b) Transaction code=“10”: A process-2 to be executed to set, in the above-mentioned control fields, a sequence of words including the bit string “SS” that are “1001SS11,” “FFH,” “FFH,” and “FFH” (UNEQ indicating a state that the resource indicated by the bit string “SS” is mounted; hereinafter referred to as “second specific words”).

(c) Transaction code=“11”: A process-3 to be executed to set, in the above-mentioned control fields, a fixed-word sequence “FFH,” “FFH,” “FFH,” and “FFH” (a prescribed alarm indication signal AIS; hereinafter referred to as “second specific words”).

By decoding a count that is supplied from the counter 42, the decoder 62 detects a period when the contents of the control fields are read from the read ports of the multiport memories 41M and 41S.

The address controlling part 61 executes one of the following processes based on individual TSI codes that are contained in a control address that is supplied through the selector 45:

Judges whether the transaction code that is contained in a TSI code concerned is “00.” If the judgment result is “true,” the address controlling part 61 executes none of the process-1 to process-3 and supplies the control address to the read ports of the multiport memories 41M and 41S as in the case of the first embodiment.

If the judgment result is “false,” the address controlling part 61 executes one of the process-1 to process-3 that corresponds to the value (one of “01,” “10,” and “11”) of the transaction code.

During execution of the process-1, process-2, or process-3, the address controlling part 61 determines, in the following manner, a read address to be supplied to corresponding read ports of the multiport memories 41M and 41S in accordance with the logical value of each bit (hereinafter referred to as “reference bit”) contained in four bytes that show the contents of UNEQ or an alarm indication signal AIS, and supplies the determined read address to the corresponding read ports during a period that has been detected by the decoder 62 as described above:

“128” if the logical value of the reference bit is equal to “1.”

“129” if the logical value of the reference bit is equal to “.”

That is, the read ports, having the 2-bit longer word length, of the multiport memories 41M and 41S are accessed in accordance with the TSI code, whereby UNEQ and an alarm indication signal AIS are input to read ports that conform to a desired frame structure and put in prescribed fields (time slots) of the frame to contain overhead or the like.

Therefore, according to this embodiment, the hardware scale is decreased, so does the running cost irrespective of the multiplicity of the principal signal, and the configuration can be standardized to a higher degree than in the conventional example that is provided with dedicated hardware like the inserter 163 shown in FIG. 15 for putting UNEQ and an alarm indication signal AIS in desired fields.

In this embodiment, the address controlling part 61 executes one of the process-1 to process-3 and during that course the address to be supplied to corresponding read ports of the multiport memories 41M and 41S is changed.

However, the invention is not limited to such a case. For example, where a period when reference bits are to be read from corresponding read ports of the multiport memories 41M and 41S are determined uniquely under synchronization with a principal signal, a read address corresponding to each transaction code may be contained in advance in a TSI code at low-order bits and the address controlling part 61 may be omitted.

In this embodiment, pieces of transmission information are multiplexed in bits in a principal signal. However, the invention is not limited to such a case. For example, when pieces of transmission information are multiplexed in octets in a principal signal, the following configuration is possible:

The word length of the multiport memories 41M and 41S is set large over 32 bits that is the sum of the word lengths of four kinds of bit string “01100000,” “00H,” “10010011,” and “FFH” that may be included in the first to third specific words.

A control address having the format of FIG. 6 is stored in the ACM parts 44M and 44S as in the case of the first embodiment.

In the first to fourth embodiments, control addresses that are stored in the ACM parts 44M and 44S are not updated at all. However, the invention is not limited to such a case. For example, control addresses that are stored in the ACM parts 44M and 44S may be updated according to an external instruction.

The operation of the fifth embodiment will be described below with reference to FIG. 4.

This embodiment is characterized in the following process that is executed by the address converting part 43.

The address converting part 43 is supplied with an address sequence having a prescribed format from a transmission apparatus, an exchange, or an apparatus that performs processing that relates to maintenance and operation. The address converting part 43 converts such an address sequence into control addresses (described above) to be stored in the storage areas of the ACM parts 44M and 44S, and supplies the control addresses to the write ports of the ACM parts 44M and 44S.

That is, addresses having any format that are supplied from a transmission apparatus, an exchange, or the like are converted into control addresses having the prescribed format and stored in the ACM parts 44M and 44S as long as the conversion is possible.

Therefore, the cross-connect switch according to this embodiment can be used flexibly in a variety of apparatuses such as a transmission apparatus and an exchange that have been repaired or relocated without the need for changing the basic configurations of those apparatuses.

In this embodiment, the address converting part 43 is dedicated hardware and all or part of its functions are realized by software that is executed by a general-purpose processor. However, the invention is not limited to such a case. All or part of those functions may be realized under any functional distribution between the address converting part 43 and a general-purpose processor or dedicated hardware (both not shown) that cooperates with the address converting part 43.

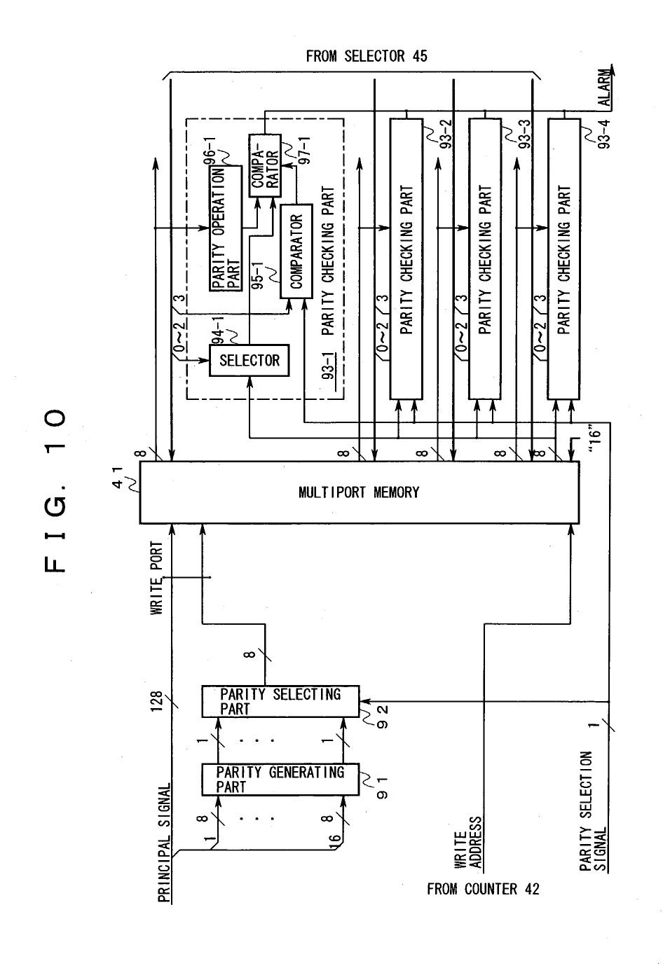

FIG. 10 shows a sixth embodiment according to the invention.

This embodiment is characterized by the following components that are added to each of the multiport memories 41M and 41S (reference symbol “41” will be hereinafter used in a description that applies to either of the multiport memories 41M and 41S) and that judge of regularity of the multiport memory 41 and output an alarm that indicates a judgment result.

Therefore, the configuration and the operation of this embodiment will be described below with an assumption that the concept of this embodiment is applied to the first embodiment among the embodiments of FIG. 4.

In this embodiment, the multiport memory 41 has a write port of 136 bits (=128 bits+8 bits) and five (=4+1) 8-bit read ports. A fixed address “16” (=128 bits/8 bits) is applied to the address input of the fifth read port. The following components are added to the multiport 41 according to the first embodiment:

A parity generating part 91 that, together with the lower-128-bit portion of the write port of the multiport memory 41, receives a principal signal of 128 bits and produces a 16-bit output.

A parity selecting part 92 that is cascade-connected to the output of the parity generating part 91 and that has a selection input to which a parity selection signal is supplied and an output that is connected to the higher-8-bit portion of the write port of the multiport memory 41.

Parity checking parts 93-1 to 93-4 that are connected to first to fourth read ports (for the sake of simplicity, they are assumed to be the four read ports that are provided in the first embodiment), respectively, of the multiport memory 41 and that are together connected to the data output of the fifth read port of the multiport memory 41.

The parity checking part 93-1 is composed of the following components:

A selector 94-1 that is connected to the data output of the fifth read port of the multiport memory 41 and that has a selection input to which the lower 3 (=log₂8) bits (including the LSB) of a read address that is supplied to the first read port of the multiport memory 41 are supplied.

A comparator 95-1 that has one input to which 1 (=log₂2) bit, immediately above the above-mentioned 3 bits, of the read address is supplied and the other input to which the above-mentioned parity selection signal is supplied.

A parity operation part 96-1 that has an 8-bit input that is connected to the data output of the first read port of the multiport memory 41.

A comparator 97-1 that has two inputs that are connected to 1-bit outputs of the parity operation part 96-1 and the selector 94-1, respectively, and an enable terminal that is connected to the output of the comparator 95-1. The output of the comparator 97-1 and the outputs of the other parity checking parts 93-2 to 93-4 realize wired-OR, and the comparator 97-1 outputs an alarm (described above).

The configurations of the parity checking parts 93-2 to 93-4 are the same as the configuration of the parity checking part 93-1 and hence will not be described.

The operation of the sixth embodiment of the invention will be described below with reference to FIG. 10.

The parity generating part 91 performs parity checks in parallel on 16 bytes that have been obtained by dividing a 128-bit word of a principal signal into 8-bit parts that are adjacent to each other, and outputs 16 parity bits indicating respective parity check results.

The parity selection signal is in synchronism with write addresses that are supplied from the counter 42 to the write port of the multiport memory 41, and is updated cyclically at a period that is integer (four (=(16 bits/8 bits)×2) or more) times a period of write address updating.

The parity selecting part 92 selects eight parity bits corresponding to the value of the parity selection signal from the 16 parity bits that are output from the parity generating part 91.

The thus-selected eight parity bits are written to a corresponding word storage area together with the 128-bit word of the principal signal. In the following description, for the sake of simplicity, it is assumed that such eight parity bits are written to a corresponding word storage area as highest 8 bits.

On the other hand, the above-mentioned fixed read address “16” (=128 bits/8 bits) is supplied to the address input of the fifth read port of the multiport memory 41. Therefore, parity bits that are the highest 8 bits of each word that is read from the multiport memory 41 are output from the fifth read port.

The operations of the individual parts of the parity checking parts 93-1 to 93-4 are the same except that the parity checking parts 93-1 to 93-4 are associated with the different read ports of the multiport memory 41. Therefore, a suffix “c” that means any of suffixes “1” to “4” will be used in the following description.

In the parity checking part 93-c, the selector 94-c selects, from eight parity bits that are read from the fifth read port of the multiport memory 41, a single parity bit (hereinafter referred to as “corresponding parity bit”) corresponding to the lowest 3 bits (including the LSB) of a read address (hereinafter referred to as “corresponding read address”) that is supplied to the corresponding read port of the multiport memory 41.

The comparator 95-c judges whether the logical value of one bit that is immediately above the lowest 3 bits (including the LSB) of the corresponding read address is equal to that of one bit that is supplied as a corresponding parity selection signal.

The parity operation part 96-c performs a parity check on a byte that is read from the corresponding read port in response to the corresponding read address and outputs one parity bit indicating a parity check result.

The comparator 97-c performs the following processing in accordance with a judgment result of the comparator 95-c:

Keeps the logical value of the above-mentioned alarm at “1” if the judgment result is “false.”

Compares the parity bit that is output from the parity operation part 96-c with the corresponding parity bit if the judgment result is “true.” The comparator 97-c changes the logical value of the above-mentioned alarm to “0” only when they are not identical.

The output ends of the comparators 97-1 to 97-4 of the parity checking parts 93-1 to 93-4 are open collector circuits, for example. Therefore, an alarm that is produced by the above-mentioned wired-OR has a logical value that is equal to “0” only if one of the parity checking parts 93-1 to 93-4 judges that the corresponding parity bit is improper.

That is, parity bits to be used for judging of the regularity of the multiport memory 41 on a read port basis are passed sequentially and cyclically from the parity selecting part 92 to the parity checking parts 93-1 to 93-4 through the multiport memory 41 without causing the word length of the multiport memory 41 to increase unduly in proportion to the multiplicity of a principal signal even if the multiplicity is high.

Therefore, in the cross-connect switch according to this embodiment as shown in FIG. 10, whether the multiport memory 41 as a major component is regular is judged with high reliability without causing undue increase in hardware scale even if the multiplicity is high. The total reliability of the cross-connect switch is kept high based on a result of the above judgment.

The above description has been made with an assumption that the concept of this embodiment is applied to the first embodiment. However, the invention is not limited to such a case; the concept of this embodiment can similarly be applied to any of the second to fifth embodiments.

In this embodiment as shown in FIG. 10, the parity generating part 91, the parity selecting part 92, and the parity checking parts 93-1 to 93-4 are added to the cross-connect switch according to the first embodiment. However, the invention is not limited to such a case and can be applied to any equipment or system that incorporates a multiport memory and in which reduction in reliability that is caused by a failure in the multiport memory is detected quickly and recovery from it is required.

The seventh embodiment according to the invention will be hereinafter described with reference to FIG. 4.

In this embodiment, an OH dropping part 50 that is composed of the following components is provided as indicated by a two-dot chain line in FIG. 4:

Multiport memories 51M and 51S that, together with the multiport memories 41M and 41S, receive a principal signal at the write ports, that receive an OH clock signal whose logical value becomes “1” only during periods when each frame of the principal signal contains prescribed overhead. One particular read port of each of the multiport memories 51M and 51S is connected to the outside.

A write address generating part 52 that receive, in addition to the above-mentioned frame pulses and the OH clock signal, OH frame pulses whose logical value becomes “1” only during a period when each frame indicated by each frame pulse contains first overhead. The output of the write address generating part 52 is connected to the address inputs of the write ports of the multiport memories 51M and 51S.

A read address generating part 53 that receives the OH clock signal and the OH frame pulses, and whose output is connected to the address input of a particular read port of each of the multiport memories 51M and 51S.

The operation of the seventh embodiment of the invention will be described below with reference to FIG. 4.

The multiport memories 51M and 51S have storage areas having the same word length and number of words as the storage areas of the multiport memories 41M and 41S do.

The write address generating part 52 counts a pulse of the OH clock signal in each period when the frame pulses and the OH frame pulses have the same logical value “1,” and analyzes a resulting count in real time according to a prescribed frame structure. In this manner, the write address generating part 52 determines one of the multiport memories 51M and SIS in which to store overhead that is indicated by a pulse of the OH clock signal as well as an address of a storage area (corresponds to one of the above-mentioned 24 words), in which to store the overhead, of the determined multiport memory.

Further, the write address generating part 52 supplies the write ports of the multiport memories 51M and 51S with a write address that indicates the above-mentioned one multiport memory and address.

Therefore, pieces of overhead that are contained in respective frames are stored repeatedly in the same storage area of each of the multiport memories 51M and 51S as long as the frame structure remains the same.

On the other hand, the read address generating part 53 has a counter that is initialized the leading edge (or trailing edge) of each OH frame pulse. By counting pulses of the OH clock signal with the counter, the read address generating part 53 sequentially supplies the first read ports of the multiport memories 51M and 51S with read addresses that indicate individual storage areas in which overhead is stored in octets and have the same format as TSI codes (mentioned above).

In this manner, parallel-serial conversion operations that are performed in the conventional example are performed in parallel and collectively by the process of reading via the read ports of the multiport memories 51M and 51S without causing the hardware scale from increasing in proportion to the multiplicity of a high-speed-interface signal irrespective of the frame structure that is indicated by the high-speed-interface signal even if the multiplicity of the high-speed-interface signal is high.

Therefore, according to this embodiment, the contents of pieces of overhead that are contained in frames are extracted by the multiport memories 51M and 51S in time-series order, temporarily stored, and then output from the first read ports of the multiport memories 51M and 51S sequentially in a serial manner. Further, they are referred to when necessary during maintenance work or operation.

In this embodiment, no processing is performed on the contents of pieces of overhead that are output from the first read ports of the multiport memories 51M and 51S sequentially in a serial manner. However, the invention is not limited to such a configuration. For example, the contents of pieces of overhead may be sent to a desired transmission channel or communication link after being converted into a bit string or a message having a proper format that should be referred to during maintenance work or operation.

In this embodiment, write addresses and read addresses that are supplied to the multiport memories 51M and 51S are both generated as a sequence of addresses that conform to a prescribed frame structure. However, the invention is not limited to such a configuration. For example, one or both of write addresses and read addresses may be updated when necessary based on externally supplied information such as a frame structure.

In this embodiment, the concept of this embodiment is applied to the first embodiment. However, the invention is not limited to such a case. For example, the concept of this embodiment can be applied to any of the second to sixth embodiments as indicated by a two-dot chain line in FIGS. 4 and 8.

In each of the above embodiments, the switch parts 40 and the OH dropping part 50 are integrated with each other so as to form an application-specific integrated circuit (ASIC). However, the invention is not limited to such a configuration. The switch parts 40 and the OH dropping part 50 may be implemented as a package (module) that incorporate those in desired numbers as long as adaptation to a desired degree of multiplicity and a desired word length and rate of a principal signal can be made reliably. Alternatively, one or both of the switch parts 40 and the OH dropping part 50 may be implemented as an ASIC(s) that incorporates the switch parts 40 or the OH dropping part 50 in a desired number.

In each of the above embodiments, the components other than the multiport memories 41M, 41M1, 41M2, 41S, 41S1, and 41S2 are integrated with the multiport memories 41M, 41M1, 41M2, 41S, 41S1, and 41S2 so as to be hardware that is formed in an ASIC. However, the invention is not limited to such a configuration. For example, all or part of the components other than the multiport memories 41M and 41S may be software that is executed by a general purpose processor as long as adaptation to a desired degree of multiplicity and a desired word length and rate of a principal signal can be made reliably.

In each of the above embodiments, the invention is applied to the cross-connect switch. However, the application range of the invention is not limited to such a cross-connect switch. For example, when implemented in the following manner, the invention can be applied to a tandem switch that is provided in a higher-rank-stage node of an STM network and performs circuit switching in a desired high-speed interface without causing any blocks or a switch that forms speech paths in a large-capacity exchange (or local switch):

The word length, the size, the number of read ports, the access time, etc. of the multiport memories 41M, 41M1, 41M2, 41S, 41S1, and 41S2 are set at values suitable for principal signals of a desired rate group or the number of principal signals of a desired rate group.

Real-time operation is assured with desired accuracy under cooperation among the multiport memories 41M, 41M1, 41M2, 41S, 41S1, and 41S2 and the parts provided around the multiport memories 41M, 41M1, 41M2, 41S, 41S1, and 41S2.

One or both of a physical structure and a mechanical structure that conform to the needs relating to maintenance and operation of the above-mentioned node or exchange are provided.

The forms of functional distribution and load distribution conform to the above needs.

In each of the above embodiments, pieces of transmission information of fields (channels) that are multiplexed in a principal signal are temporarily stored in the multiport memories 41M, 41M1, 41M2, 41S, 41S1, and 41S2 and read out in desired periods, whereby cross-connect is attained. However, the invention is not limited to such a configuration. For example, each of the multiport memories 41M, 41M1, 41M2, 41S, 41S1, and 41S2 may be replaced by any of the following circuits:

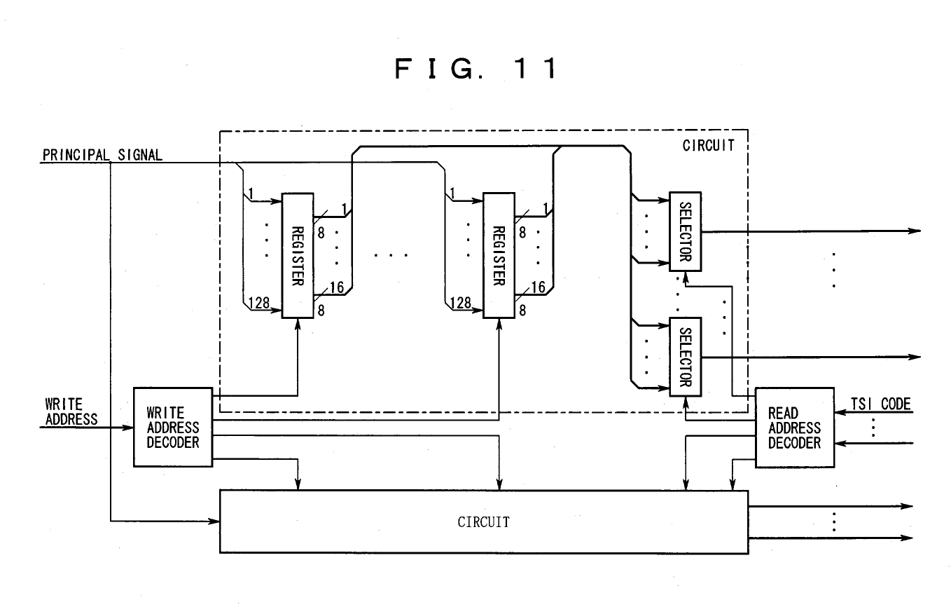

I. A circuit that is composed of the following write address decoder, registers, read address decoder, and selectors (see FIG. 11).

i) A write address decoder that decodes a write address (including plane switching).

ii) Registers that receive a common principal signal at parallel input terminals and hold it in units of a 128-bit word according to a selective load signal that is a decoding result of the write address decoder.

iii) A read address decoder that decodes (including plane switching), in parallel, TSI codes that are contained in respective control addresses (described above).

iv) Selectors that correspond to the respective read ports of each multiport memory and select a byte corresponding to a read address decoding result from a prescribed number (16) of bytes that are included in each word that is held by the registers.

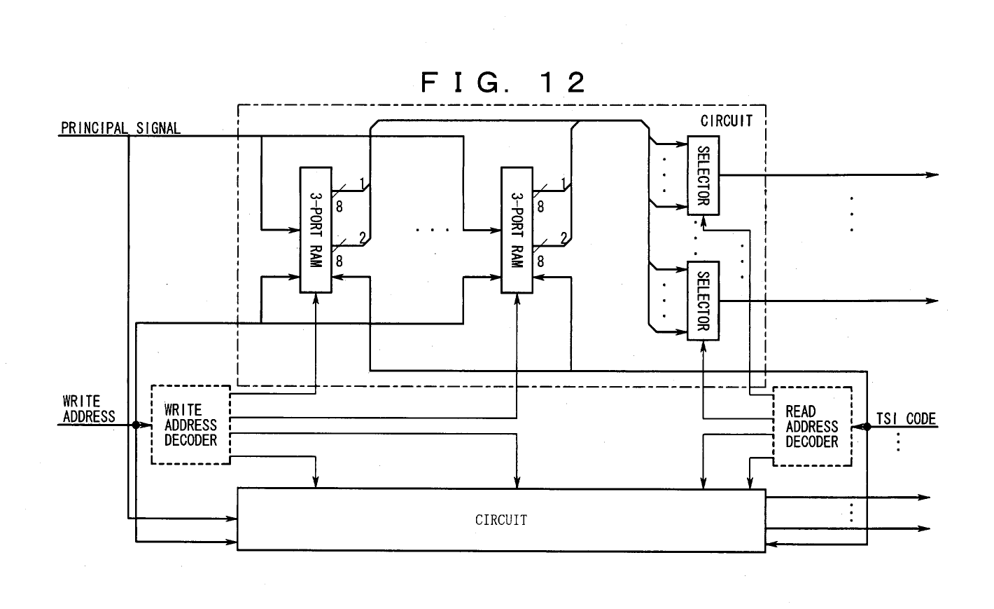

II. A circuit that is different from the circuit of FIG. 11 in the following points (see FIG. 12):

A prescribed number of 3-port RAMs are provided in place of the registers of item I-ii).

One or both of the write address decoder of item I-i) and the read address decoder of item I-iii) are replaced by the write ports and the read ports of the 3-port RAMs.

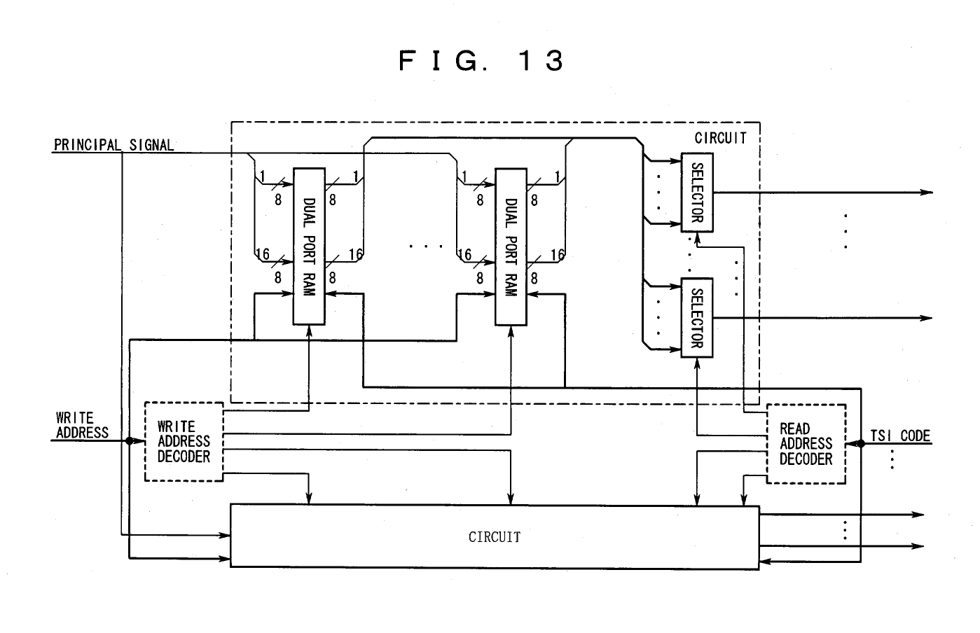

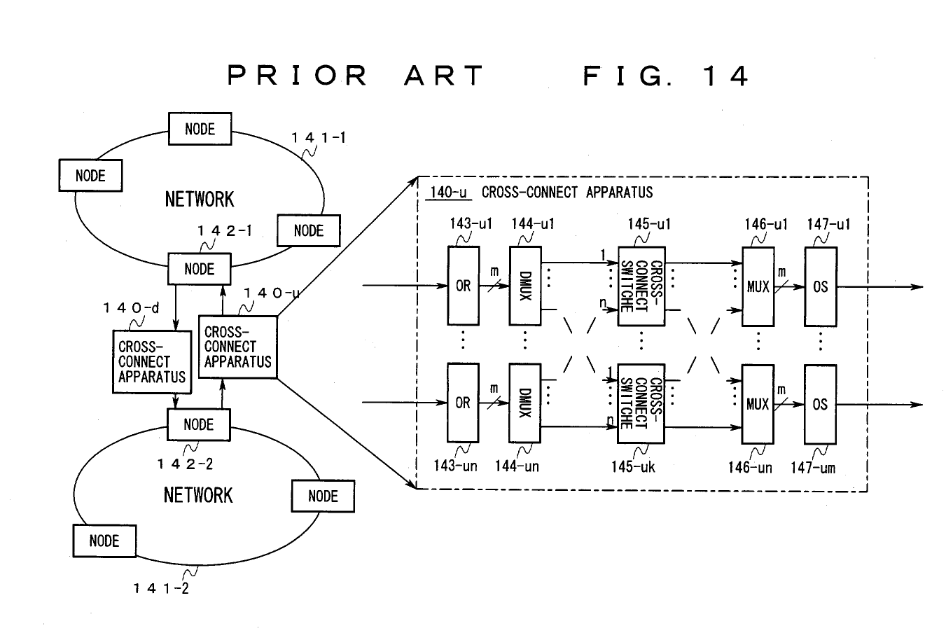

III. A circuit that is different from the circuit of FIG. 12 in that dual-port RAMs are provided in place of the 3-port RAMs (see FIG. 13).

The invention is not limited to the above embodiments and various modifications may be made without departing from the spirit and scope of the invention. Any improvement may be made in part or all of the components.

It should be noted that some of the new techniques described in the above embodiments will not be described in claims, but described as additional claims below instead.

[additional claim A] The cross-connect switch according to any of claims 1, 3, 5, 6, 7, and 8 to be described later, wherein:

the multiport storage section has storage areas for storing data that are different from data of the plurality of channels which are time-division-multiplexed and subject to cross connect; and

the controlling section has a function of supplying addresses of the storage areas in which the different data are stored to the read ports of the multiport storage section.

[additional claim B] The cross-connect switch according to additional claim A, wherein the controlling section reads one of UNEQ and AIS by supplying addresses of the storage areas in which the different data are stored to the read ports of the multiport storage section.

[additional claim C] The cross-connect switch according to additional claim A, wherein:

the different data are a plurality of element data of one of a maintenance message and an operation message; and

the controlling section controls a combination of the element data by supplying addresses of the storage areas in which the different data are stored to the read ports of the multiport storage section, and thereby reads one of the maintenance message and the operation message.

[additional claim D] The cross-connect switch according to any of claims 1, 3, 5, 6, 7, and 8 to be described later, wherein:

a part of a word to be written to all or part of the storage areas of the multiport storage section includes information relating to one or both of maintenance and operation; and

an address of a storage area of the multiport storage section in which the information is stored is stored in a storage area of the address storage section which is to be read in cooperation with the controlling section at a prescribed instance suitable for a frame structure that is employed in time division multiplexing of the channels.

[additional claim E] The cross-connect switch according to any of claims 1, 3, 5, 6, 7, and 8 to be described later, wherein

the address storage section comprises a section that enables updating of addresses to be stored in storage areas of the address storage section in response to a request from an exterior.

[additional claim F] The cross-connect switch according to any of claims 1, 3, 5, 6, 7, and 8 to be described later, wherein

the address storage section converts formats of addresses supplied externally into a format that conforms to the sequence of addresses, and stores a conversion result in corresponding storage areas.

What is claimed is:

1. A cross-connect switch comprising:
a multiport storage section having a plurality of read ports that are randomly accessible and a plurality of write ports to which data of a plurality of channels are individually input in parallel, the plurality of channels being time-division-multiplexed;
an address storage section for storing addresses to be supplied to the respective read ports; and
a controlling section for supplying write addresses sequentially to each of said write ports to write data in units of a plurality of channels, and for supplying addresses stored in said address storage section to said respective read ports.

2. The cross-connect switch according to claim 1, wherein
said controlling section supplies a sequence of addresses stored in said address storage section to all or part of said read ports at a frequency that is shorter than or equal to a ratio, the ratio being a ratio of a frequency at which said write addresses are updated to a maximum number of channels to which transmission information of a co-channel is to be delivered during a process of cross-connect.

3. A cross-connect switch comprising:
a multiport storage section having a plurality of read ports that are randomly accessible and a plurality of write ports to which data of a plurality of channels are individually input in parallel, the plurality of channels being time-division-multiplexed;
an address storage section for storing addresses to be supplied to the respective write ports; and
a controlling section for supplying read addresses sequentially to each of said read ports to read data in units of a plurality of channels, and for supplying addresses stored in said address storage section to said respective write ports.

4. The cross-connect switch according to claim 3, wherein
said controlling section sequentially supplies write addresses stored in said address storage section to all or part of said write ports at a frequency that is shorter than or equal to a ratio, the ratio being a ratio of a frequency at which said write addresses are updated to a maximum number of channels to which transmission information of a co-channel is to be delivered during a process of cross-connect.

5. A cross-connect switch comprising:
a plural number n of multiport storage sections each having a plurality of read ports that are randomly accessible and a plurality of write ports to which data of a plurality of channels are individually input in parallel, the n being a number equal to a maximum number N of channels to which data of a co-channel is to be delivered, the plurality of channels being time-division-multiplexed;
an address storage section for storing addresses to be supplied to said read ports; and
a controlling section for supplying write addresses sequentially to each of said write ports to write data in units of a plurality of channels, and for supplying addresses stored in said address storage section to said read ports.

6. A cross-connect switch comprising:
a plural number n of multiport storage sections each having a plurality of read ports that are randomly accessible and a plurality of write ports to which data of a plurality of channels are individually input in parallel, the n being a number smaller than a maximum number N of channels to which data of a co-channel is to be delivered, the plurality of channels being time-division-multiplexed;
an address storage section for storing addresses to be supplied to said read ports; and
a controlling section for supplying write addresses sequentially to each of said write ports to write data in units of a plurality of channels, and for supplying addresses stored in said address storage section to said read ports at a frequency that is equal to or smaller than a quotient of a frequency at which write addresses are updated and a ratio of the maximum number N to the plural number n.

7. A cross-connect switch comprising:
a plural number n of multiport storage sections each having a plurality of read ports that are randomly accessible and a plurality of write ports to which data of a plurality of channels are individually input in parallel, the n being a number equal to a maximum number N of channels to which data of a co-channel is to be delivered, the plurality of channels being time-division-multiplexed;
an address storage section for storing addresses to be supplied to said write ports; and
a controlling section for supplying read addresses sequentially to each of said read ports to read data in units of a plurality of channels, and for supplying addresses stored in said address storage section to said write ports.

8. A cross-connect switch comprising:
a plural number n of multiport storage sections each having a plurality of read ports that are randomly accessible and a plurality of write ports to which data of a plurality of channels are input in parallel, the n being a number smaller than a maximum number N of channels to which data of a co-channel is to be delivered, the plurality of channels being time-division-multiplexed individually;
an address storage section for storing addresses to be supplied to said write ports; and
a controlling section for supplying read addresses sequentially to each of said read ports to read data in units of a plurality of channels, and for supplying addresses stored in said address storage section to said write ports at a frequency that is equal to or smaller than a quotient of a frequency at which read addresses are updated and a ratio of the maximum number N to the plural number n.

9. A route monitoring assist apparatus comprising:
a storage section for cyclically holding transmission information of a plurality of time-division-multiplexed channels, in units of a word having a length that is plural times longer than a word length of said transmission information, said storage section having write ports and read ports, the read ports having a word length shorter than a word length of the write ports and being randomly accessible; and
a controlling section for generating addresses of storage areas of said storage section in synchronism with said channels, and for supplying said addresses to said read ports, the storage areas being storage areas in which information contained in a desired field of a frame is held, the frame indicating said transmission information of said channels.

10. A route monitoring assist apparatus comprising:
a storage section for cyclically holding transmission information of a plurality of time-division-multiplexed channels, in units of a word having a length that is plural times longer than a word length of said transmission information, said storage section having write ports and read ports, the read ports having a word length shorter than a word length of the write ports and being randomly accessible; and
a holding section for holding addresses which are externally supplied and of storage areas of said storage section, the storage areas being storage areas in which information contained in a desired field of a frame is held, the frame indicating said transmission information of said channels; and
a controlling section for supplying said addresses held by said holding section to said read ports in synchronism with said channels.

11. The route monitoring assist apparatus according to claim 9, further comprising a converting section for informing a sequence of pieces of information to an exterior in a prescribed format, the sequence being read from said storage section via said read ports.

12. The route monitoring assist apparatus according to claim 10, further comprising a converting section for informing a sequence of pieces of information to an exterior in a prescribed format, the sequence being read from said storage section via said read ports.
